(19) United States
(12) Patent Application Publication
(10) Pub. No.: US 2013/0210471 A1
(43) Pub. Date: Aug. 15, 2013

(54) SHORT RANGE AND LOW FREQUENCY TEXT MESSAGING SYSTEM

(71) Applicant: CC TECHNOLOGIES INC., (US)

(72) Inventor: Danny LESSARD, Blainville (CA)

(73) Assignee: CC TECHNOLOGIES INC., Blainville (CA)

(21) Appl. No.: 13/762,830

(22) Filed: Feb. 8, 2013

Related U.S. Application Data
(60) Provisional application No. 61/597,355, filed on Feb. 10, 2012.

(51) Int. Cl. H04W 4/12

(52) U.S. Cl. CPC H04W 4/12
USPC 455/466

(57) ABSTRACT

A portable device for communicating text messages over a wireless communication link. Short range communications are enabled over open frequencies between at least two devices. The devices are pre-coded to only exchange messages with previously identified devices.

### CROSS-REFERENCE TO RELATED APPLICATIONS

This application claims priority under 35 USC §119(e) of U.S. Provisional Patent Application No. 61/597,355 filed on Feb. 10, 2012, the contents of which are hereby incorporated by reference.

### TECHNICAL FIELD

The present invention relates to the field of two-way text messaging systems.

### BACKGROUND OF THE ART

Because messaging can be less intrusive than voice communications, it has become a popular mode of communication with text messaging currently being the most widely used mobile data service.

Various devices, such as cell phones, which allow text-based communication between two or more participants, have been disclosed. However, communications on most of these devices are only available if users subscribe to a service plan, which provides them access to a cellular network. Communications therefore come with a cost. In addition, these devices typically allow enhanced modes of communication other than text-based. For instance, live voice or video calling may be provided. These additional features thus add to the complexity and the cost of the device. Moreover, these devices may suffer from incomplete network coverage, especially in remote areas. Other devices, such as two-way radios, lack privacy particularly in congested areas in addition to providing noisy and unreliable signals.

There is therefore a need to improve on the available devices for text messaging functions.

### SUMMARY

There is described herein a method and system for communicating text messages over a short-range wireless communication link using low frequencies.

In accordance with a first broad aspect, there is provided a portable telecommunication apparatus for wirelessly sending and receiving text messages, the apparatus comprising: a memory for storing at least one matching device identifier associated with the apparatus, the at least one matching device identifier corresponding to at least one matching device for which the apparatus is enabled to send and receive the text messages; a transceiver for sending and receiving the text messages over a wireless personal area network, the received text messages each having encoded therewith a unique sender identifier corresponding to an originating device; a processor for comparing the sender identifier from a received text message to the at least one matching device identifier and accepting the received text message when the sender identifier corresponds to the at least one matching device identifier; and a display module for displaying the accepted text message.

Still in accordance with another broad aspect, there is also provided a telecommunication system for wirelessly sending and receiving text messages within a geographical area, the system comprising a portable apparatus comprising a memory for storing at least one matching device identifier associated with the apparatus, the at least one matching device identifier corresponding to at least one matching device for which the apparatus is enabled to send and receive the text messages, a transceiver for sending and receiving the text messages over a wireless personal area network within a given communication range, the received text messages each having encoded therewith a unique sender identifier corresponding to an originating device, a processor for comparing the sender identifier from a received text message to the at least one matching device identifier and accepting the received text message when the sender identifier corresponds to the at least one matching device identifier, and a display module for displaying the accepted text message; and a portable antenna provided within the geographical area for amplifying a signal sent by the transceiver, thereby increasing the communication range of the transceiver.

Still in accordance with another broad aspect, there is also provided a computer-implemented method for wirelessly sending and receiving text messages, the method comprising executing on a processor program code for: storing at least one matching device identifier associated with a portable telecommunication apparatus, the at least one matching device identifier corresponding to at least one matching device for which the apparatus is enabled to send and receive the text messages; sending and receiving the text messages over a wireless personal area network, the received text messages each having encoded therewith a unique sender identifier corresponding to an originating device; comparing the sender identifier from a received text message to the at least one matching device identifier and accepting the received text message when the sender identifier corresponds to the at least one matching device identifier; and displaying the accepted text message.

Still in accordance with another broad aspect, there is also provided a computer readable medium having stored thereon program code executable by a processor for wirelessly communicating text messages, the program code executable for: storing at least one matching device identifier associated with a portable telecommunication apparatus, the at least one matching device identifier corresponding to at least one matching device for which the apparatus is enabled to send and receive the text messages; sending and receiving the text messages over a wireless personal area network, the received text messages each having encoded therewith a unique sender identifier corresponding to an originating device; comparing the sender identifier from a received text message to the at least one matching device identifier and accepting the received text message when the sender identifier corresponds to the at least one matching device identifier; and displaying the accepted text message.

### BRIEF DESCRIPTION OF THE DRAWINGS

Further features and advantages of the present invention will become apparent from the following detailed description, taken in combination with the appended drawings, in which:

FIG. 1 is a schematic diagram of a short range and low frequency text messaging system in accordance with an illustrative embodiment of the present invention;

FIG. 2 is a schematic diagram of a private text messaging device in accordance with an illustrative embodiment of the present invention;

FIG. 3 is a schematic diagram of an application running on the processor of FIG. 2;

FIG. 4 is a schematic diagram of a short range and low frequency text messaging system in accordance with an alternative illustrative embodiment of the present invention;

FIG. 5 is a schematic diagram of a localization of antennas for use with the device of FIG. 2;

FIG. 6 is a schematic diagram of a short range and low frequency text messaging system used on a camping ground in accordance with an illustrative embodiment of the present invention;

FIG. 7 is a schematic diagram of a short range and low frequency text messaging system used in a safety application in accordance with an illustrative embodiment of the present invention;

FIG. 8 is a schematic diagram of a short range and low frequency text messaging system used in a safety application in accordance with an alternative illustrative embodiment of the present invention;

FIG. 9a is a flowchart of a method of receiving a text message in accordance with an illustrative embodiment of the present invention; and

FIG. 9b is a flowchart of a method of sending a text message in accordance with an illustrative embodiment of the present invention.

It will be noted that throughout the appended drawings, like features are identified by like reference numerals.

### DETAILED DESCRIPTION

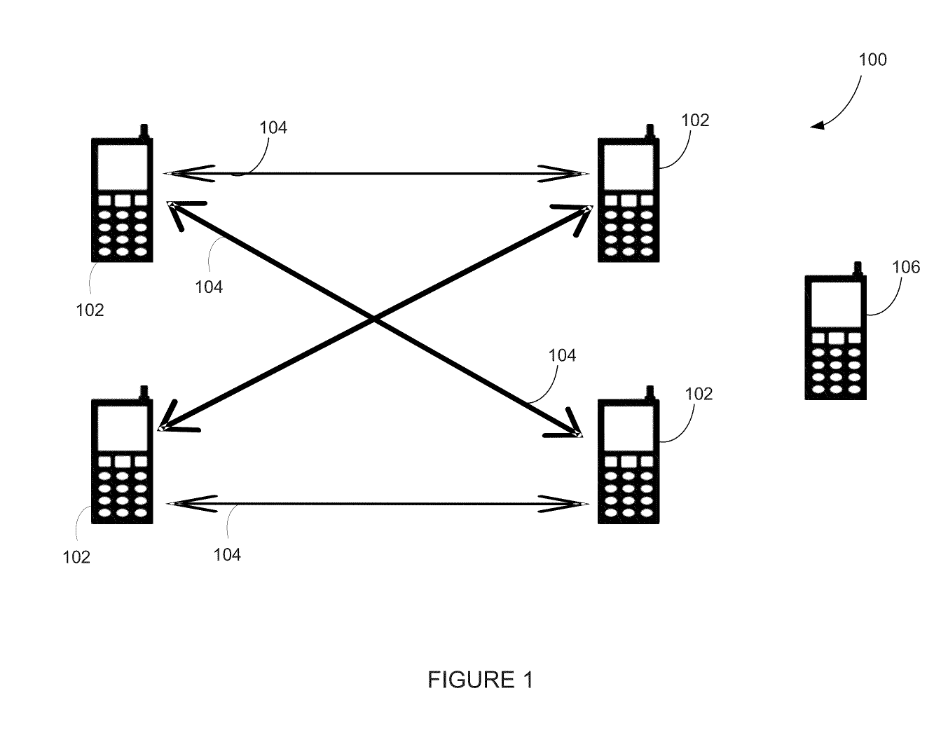

Referring to FIG. 1, a communication system 100 for sending and receiving text messages over short distances and low frequencies will now be described. The system 100 comprises a plurality of hand-held portable devices as in 102 adapted to communicate using a wireless bi-directional communication link 104. Each two-way device 102 illustratively has a unique identifier (ID) associated therewith and is pre-coded with the IDs of other devices as in 102 it may communicate with. Thus, a given device 102 can only send/receive data to/from at least one other previously identified device as in 102 (hereinafter referred to as a “matching” device). As such, a device 106, which has not been pre-identified, will not be able to communicate with the device 102. Although the devices 102 will illustratively be pre-coded in pairs and provided as such, a plurality of devices 102 may be pre-coded so as to enable communication between more than two such devices. A private network of devices as in 102 can therefore be created over a desired geographical area, and this even if the users of the devices 102 are in movement. For instance, the devices as in 102 may be used on board a vehicle (not shown), or the like.

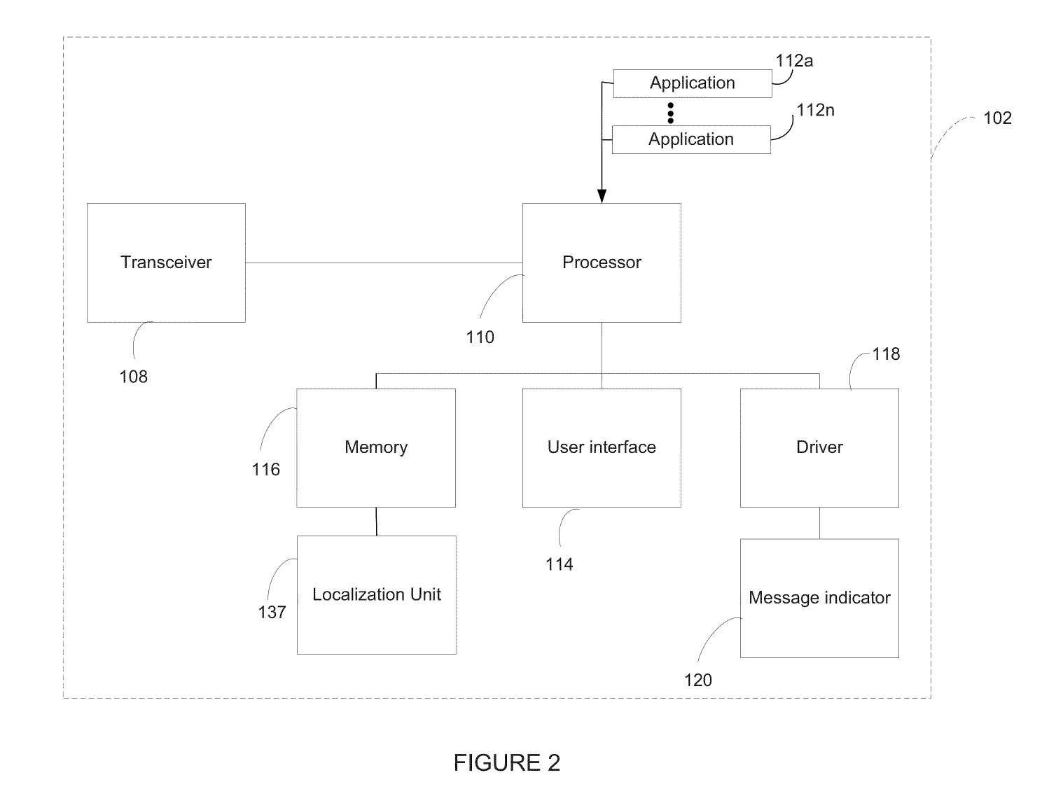

Referring now to FIG. 2, each device 102 illustratively has a width of about 6.5 centimeters, a length of about 11 centimeters, and a thickness of about 1.5 centimeters. A device 102 illustratively comprises a transceiver 108, which comprises both a transmitter and a receiver combined and sharing common circuitry. The transceiver 108 enables communications between matching devices as in 102 of a group of pre-coded devices. The transceiver 108 provides its output to a processor 110 used for decoding and processing text messages received at or sent by the transceiver 108.

The processor 110 may be any device that can perform operations on data. Examples are a central processing unit (CPU), a front-end processor, and a microprocessor. A plurality of applications 112a . . . 112n are illustratively running on the processor 110 for performing operations required at the processor 110. It should be understood that while the applications 112a . . . 112n presented herein are illustrated and described as separate entities, they may be combined or separated in a variety of ways.

The device 102 may further comprise a display module or user interface 114 and a memory 116 coupled to the processor 110. The user interface 114 is illustratively used for displaying text data as well as providing user functions, such as message compose, send, delete or duplicate functions. For this purpose, the user interface 114 comprises a screen (not shown), e.g. a Liquid Crystal Display (LCD) screen, for displaying information to a user and an input assembly (not shown) such as a tactile keyboard and/or backlit buttons, which when pressed provide the desired user functions associated therewith. The device 102 illustratively further comprises a driver 118, which is connected to the processor 110 and coupled with a message indicator 120 used to alert the user when a message is received. The message indicator 120 may comprise a buzzer, a Light Emitting Diode (LED), an alarm device, or the like. Additional features such as an input/output port, e.g. a Universal Serial Bus (USB) port, for connecting to an external device, a long-life battery and a 110 volts base with integrated charging unit and antenna (none shown) may also be provided with the device 102. The USB port may for example be used to connect to a laptop computer for downloading text messages stored on the device 102 using an appropriate protocol.

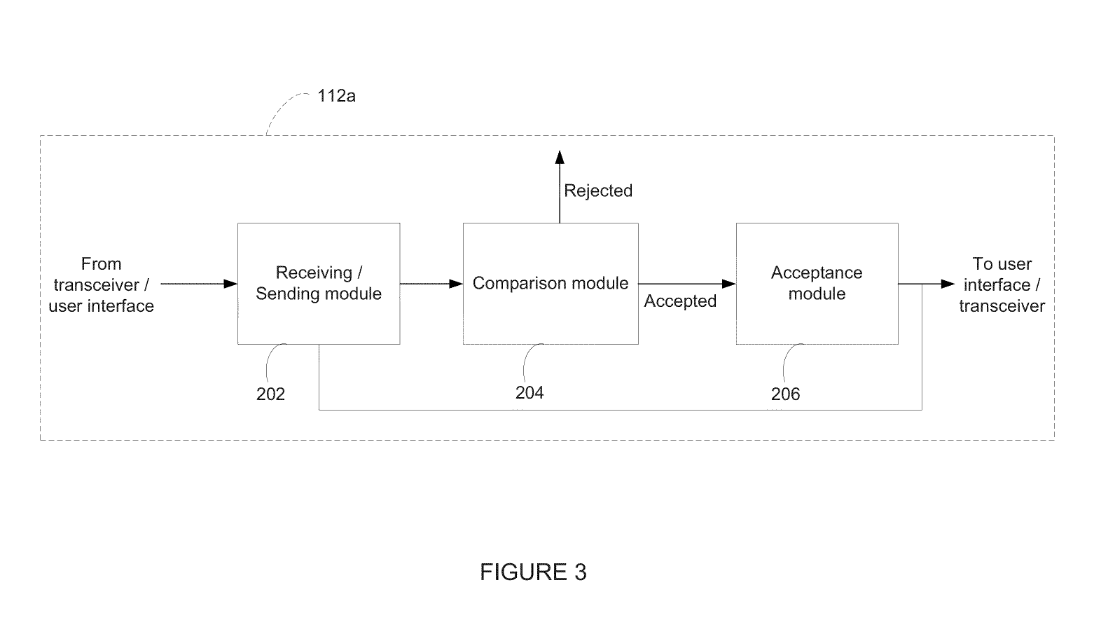

Referring to FIG. 3 in addition to FIG. 2, a list of the previously identified IDs of the devices matching the device 102 is first stored in the memory 116 the device 102. A message intended for the device 102 is illustratively received from the transceiver 108 at a receiving/sending module 202 of the application 112a. Upon receiving the message, a comparison module 204 of the application 112a checks authentication credentials associated with the message in order to identify whether the latter has been sent from a device entitled to communicate with the device 102. The authentication credentials include the unique ID of the sending device. If the comparison module 204 determines that the ID matches that of one of the list of previously identified devices, the message is transferred to an acceptance module 206 where the text data is processed for display on the user interface 114. Alternatively, the ID of the sending device may be compared to that of the receiving device rather than to a list of previously identified devices. In this case, matching devices would be pre-coded with the same ID. Also alternatively, the list of previously identified devices may have a common prefix or postfix and if the comparison module 204 determines that the prefix or postfix of the ID of the sending device matches the list, the sending device is authenticated. If the credentials of the sending device are not authenticated, the message is rejected by the comparison module 204 and never displayed to the user.

A similar process is illustratively performed when the user of the device 102 wishes to send a message to a recipient device. After the matching device identifiers have been stored in the memory 116, the message is compiled on the user interface 114 and transmitted to the receiving/sending module 202 of the application 112a. In the case where each device 102 can only communicate with a single matching device 102, there will be no need for the user to specify a recipient and the compiled message is sent directly to its destination. Alternatively, the recipient may be selected from the list of previously identified devices, which would be presented to the user on the user interface 114. In this manner, the recipient is always a matching device as in 102 and the comparison module 204 need not check the recipient's authentication credentials prior to transmitting the message. In these cases, the compiled message may be sent directly from the from the receiving/sending module 202 to the transceiver 108 without going through the comparison module 204.

Another alternative would be for the user to enter information, such as a device number or ID, associated with a recipient device, which may or may not be a matching device as in 102. In the latter case, the comparison module 204 would then check whether this information corresponds to one of the IDs from the stored list of previously identified devices (or alternatively to the ID of the sending device 102). If there is a match, the comparison module 204 sends the text data to the acceptance module 206. The acceptance module 206 in turn processes the text data and the message is sent to the transceiver 108 for transmission to the recipient over the link 104. If the credentials of the recipient device are not authenticated by the comparison module 204, the message cannot be transmitted and is rejected. A notification is illustratively displayed on the user interface 114.

All text data may further be stored in the memory 116 whose total capacity depends on the volume of characters in the data to be stored. The memory 116 also includes the list of the previously identified IDs of the devices matching the device 102 together with the unique ID of the device 102 itself. The memory 116 may include one or more storage mediums, including a hard-drive, flash memory, optical storage media such as a videodisc or a compact disc, permanent memory such as Read-Only Memory (ROM), Erasable Programmable Read-Only Memory (EPROM), semi-permanent memory, such as Random Access Memory (RAM), cache, or the like.

Illustratively, any known communication protocols that enable devices within a computer network to exchange information may be used to enable communication between the various components of the system 100. Examples of protocols are as follows: IP (Internet Protocol), UDP (User Datagram Protocol), TCP (Transmission Control Protocol), DHCP (Dynamic Host Configuration Protocol), HTTP (Hypertext Transfer Protocol), FTP (File Transfer Protocol), Telnet (Telnet Remote Protocol), SSH (Secure Shell Remote Protocol).

In order for a user to send a text message, a suitable text messaging standard, such as Short Messaging Services (SMS) or Enhanced Messaging Service (EMS) is implemented by a text message application (not shown) hosted by the devices as in 102. After compiling the message via the user interface 114, the user may choose to send the message to a matching device 102 by pressing the corresponding button on the input assembly. The radio communication link 104 is then established between the matching devices as in 102 through a bidirectional communication channel (not shown), thereby allowing the pair of devices as in 102 to exchange text messages. The devices 102 illustratively have a range of communication (i.e. the distance over which messages can be sent and received) of at least several hundred meters, e.g. 500 meters, for outdoor applications. A warning signal, such as a beeping noise, may be implemented in the device 102 to alert users when they are moving out of communication range from other matching devices 102. Moreover, the communication link 104 is such that the devices 102 are able to communicate over the desired range without being affected by obstacles such as walls and doors.

To ensure that the devices 102 do not need to access a cellular network for communicating, thus avoiding the expense of subscribing to a service plan, a Wireless Personal Area Network (WPAN) communication protocol, such as ZigBee™, may be used over an open radio-frequency (RF) or channel, such as 2.4 GHz. Communications between devices as in 102 operating on this frequency, which serves as a physical medium for carrying the communicated information, can therefore remain free. Although other equivalent short-range communication technologies may be used, ZigBee™ has the advantage of being simpler and less expensive than WPAN protocols, such as Bluetooth™. Indeed, ZigBee™ uses small, low-power digital radios and is therefore targeted at RF applications that require a low data rate, long battery life, and secure networking.

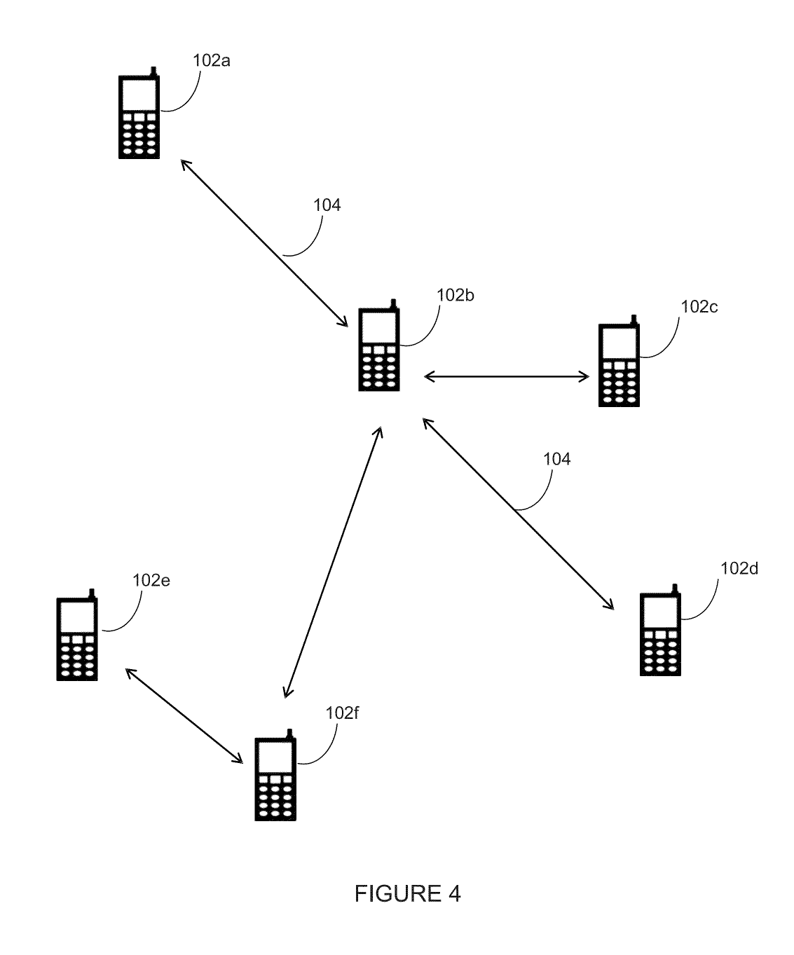

Referring now to FIG. 4, the devices as in 102 may be arranged in a mesh topology in order to enable a device 102 to reach other devices as in 102, which are further away than the device's communication range. Indeed, in mesh networking, each node in the network not only captures and disseminates its own data, but also collaborates to propagate the data in the network, thus serving as a relay for other adjacent nodes. Mesh networks thus ensure that, when one node within the network can no longer operate, the remaining nodes can still communicate with one another either directly or through one or more intermediate nodes. Redundancy and reliability is therefore achieved by significantly increasing the communication range of each device.

Still referring to FIG. 4, a device 102b is illustratively connected to other devices 102a, 102c, 102d, 102e, and 102f and acts as a relay between any pair of the devices 102a, 102c, 102d, 102e, and 102f, for example devices 102a and 102d, which are not in direct communication with one another. As a result, by passing through device 102b to which it is adjacent and directly connected over the link 104, the device 102a can reach the device 102d (and vice versa) although there is no direct communication link 104 between the two. Using the device 102b as a relay, the communication range of the devices 102a and 102d can therefore be doubled. In the example of FIG. 4, it is even possible to triple the communication range of the devices 102a and 102e. For example, assuming that this communication range is 500 meters, the illustrated mesh topology allows for the device 102a to reach the device 102e (and vice versa) using devices 102b and 102f as relays. The communication range of the device 102a therefore reaches three times 500 meters, i.e. 1500 meters. It will be apparent that as more devices as in 102b and 102f are used as relays by a given device as in 102a to transmit data to another device as in 102e, greater communication ranges between sender and recipient can be achieved.

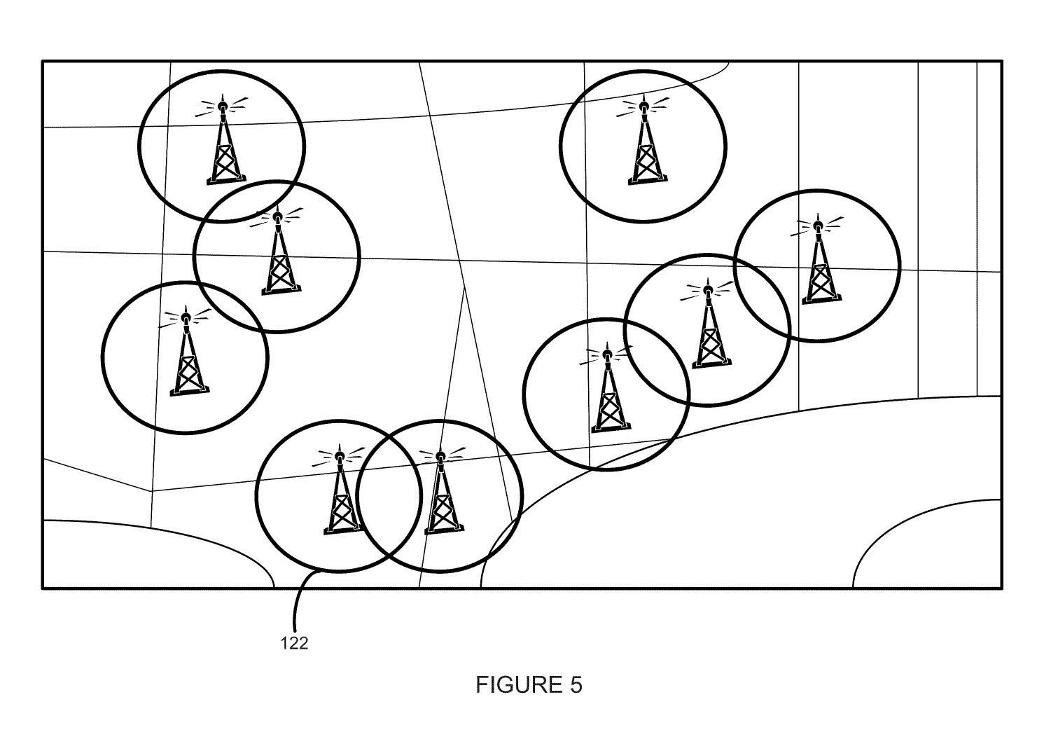

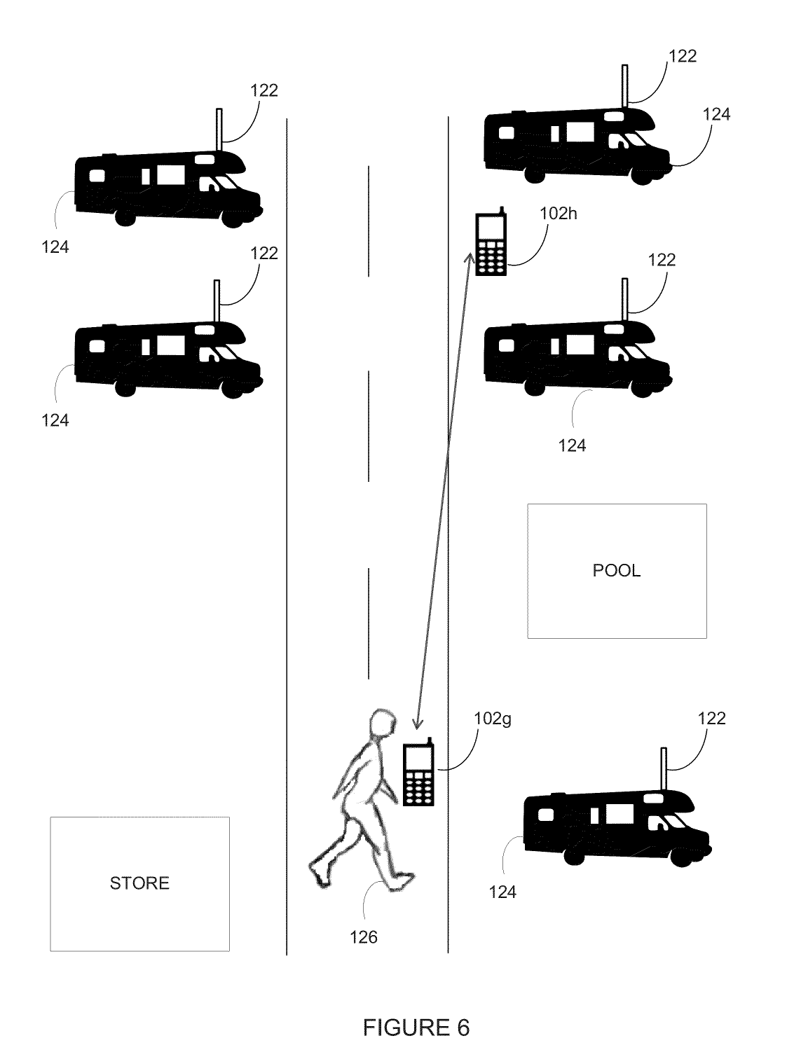

Referring now to FIG. 5 and FIG. 6, the communication range of the devices as in 102 may be further increased using portable antennas as in 122. The antennas as in 122 may be provided separately from the devices 102 and are adapted to be positioned on buildings, vehicles, or the like. In order to adapt to the feature they are mounted to, the antennas as in 122 may have an adjustable height. For example, the height of the antennas 122 may be small, e.g. 30 centimeters, or large. The antennas as in 122 may be installed in a plurality of locations within a given geographical area, such as a city, in order to increase the communication range of the devices as in 102 within the area. In this manner, the communication system (reference 100 of FIG. 1) may be used in both public areas, such as parks, camping grounds, and residential areas. For example, antennas as in 122 may be installed in parks, malls, schools, museums, libraries, office buildings, and the like. In the illustrated embodiment, devices 102g and 102h are used on a camping ground and a plurality of antennas 122 are mounted on camping cars as in 124. A user 126 wishing to establish a communication with the distant device 102h is then able to do so using an antenna 122, which significantly amplifies the signal of the user's own device 102g.

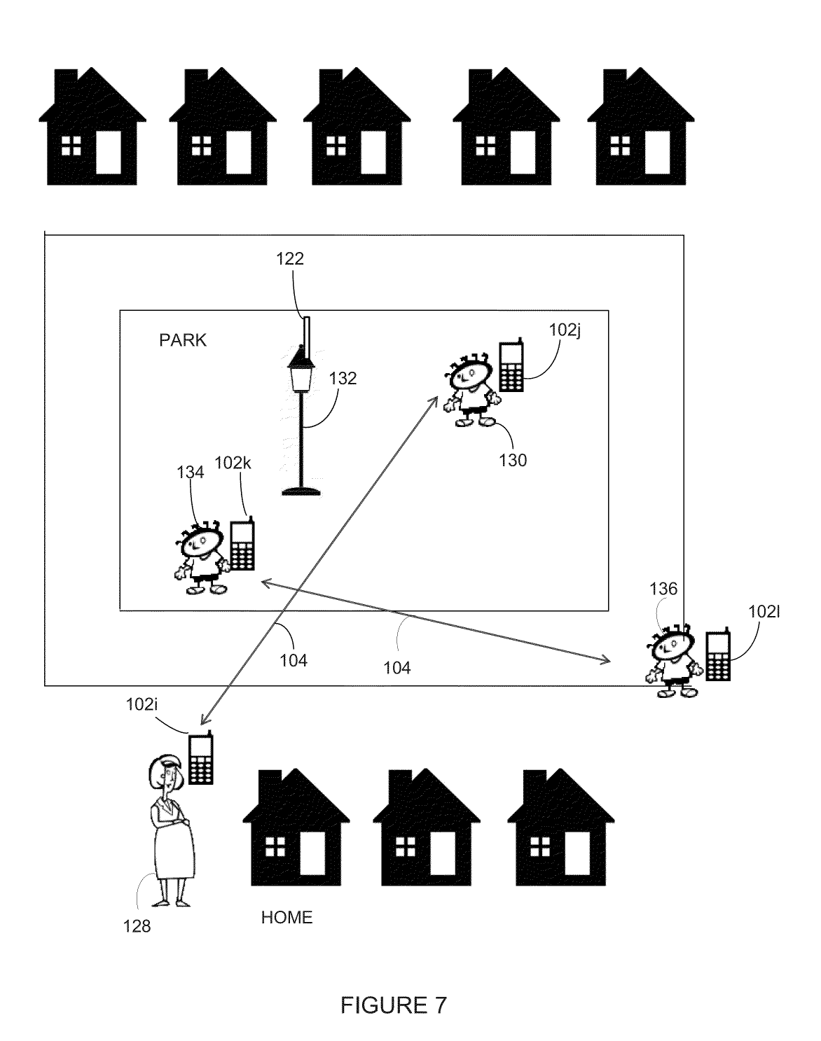

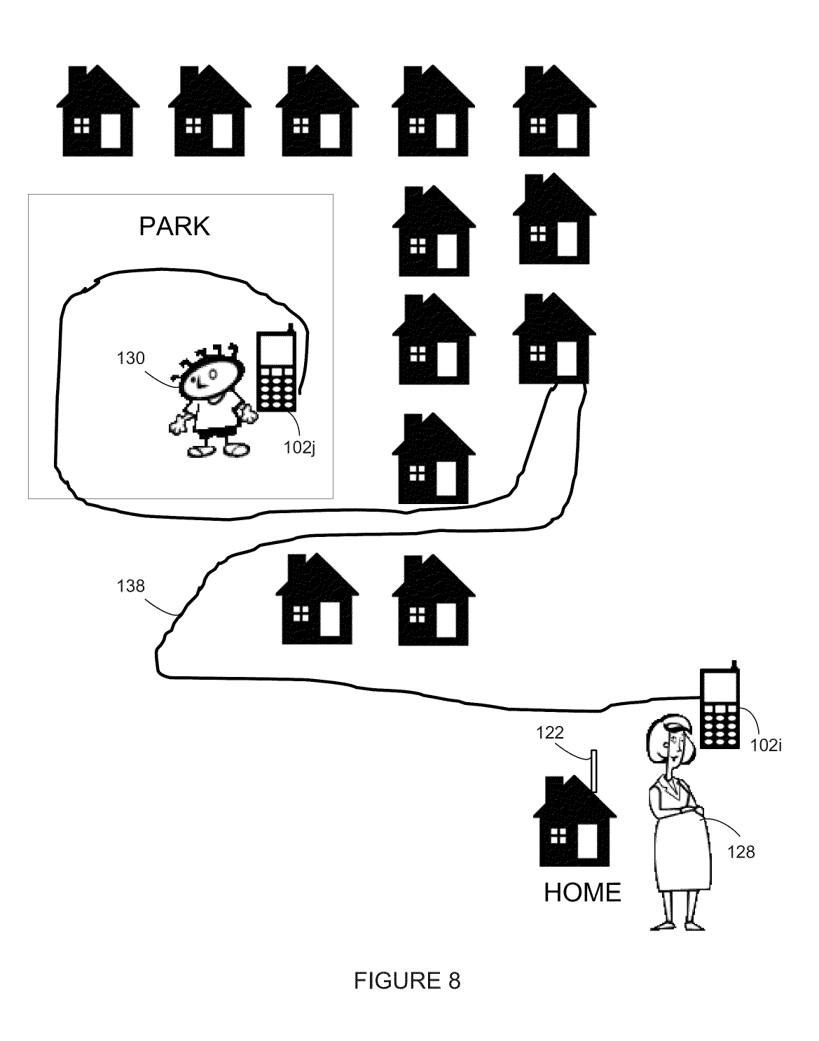

Referring to FIG. 7 and FIG. 8, the devices as in 102 allow users to stay in touch while providing a low-cost alternative to cell phones. As such, they are of strong interest for special users, such as children, elderly people, the visually impaired, or the like. For such users, the user interface 114 of the devices as in 102 may be simplified to only include a limited number of input functions, such as “Start”, “End”, and “Emergency/Panic” buttons, and associated visual indicators. Accidental actuation of these buttons may be further prevented by defining a predetermined button hold down period.

A parent 128 may for example own a device 102i and provide his or her child 130 with a device 102j matching the device 102i. When the child 130 is nearby yet out of view or even further away from the parent 128, parent 128 and child 130 can therefore still communicate over the communication link 104 using their matching pair of devices 102i, 102j. Although text messages will illustratively be exchanged within the communication range of the devices 102i and 102j, as discussed herein above, the communication range may be increased by using an antenna 122 installed in a public area, such as the park in which the child 130 is playing. The antenna 122 may for instance be mounted on a lamppost 132.

As discussed herein above, since the devices 102i and 102j are pre-coded and can only communicate with each other, a bidirectional communication link 104 will only be established between the parent 128 and the child 130. No communication link 104 will be established between the parent 128 and other children as in 134 and 136 whose devices 102k and 102l are not pre-coded to match the device 102i. It will also be apparent that the two children 134 and 136 may communicate with one another if they each use one of a pair of matching devices 102k, 102l. A plurality of the pre-coded devices as in 102i, 102j may also be provided to an adult as in 128 and a plurality of children as in 130 in order to ease supervision of the children as in 130 even in crowded places. This proves useful in numerous applications, such as when pupils are traveling together under the supervision of a single teacher during a field trip.

Referring back to FIG. 2 in addition to FIG. 8, the device 102j illustratively includes a unit 137 having localization functionality for locating and tracking the movement of a user, such as a child 130. Any suitable localization technique, such as using the Global Positioning System (GPS), may be used. In this case, the locative information of the device 102j, i.e. its coordinates, is sent at regular intervals by a GPS unit provided on the device 102j to a GPS receiver provided on the matching device 102i. Should the child 130 be in movement, his or her successive coordinates on a route 138 may be monitored and saved in the memory 116 of the device 102j for subsequent retrieval if needed. An “Emergency/Panic” button (not shown) provided on the device 102j and coupled to the GPS unit may also enable precise localization of the device 102j. In this manner, pressing the “Emergency/Panic” button provides the child 130 with the current position of the device 102j.

This proves advantageous for safety applications, especially when children are involved. For example, if the child 130 finds himself lost or in a challenging or emergency situation and does not know the way back home, he or she can press the “Emergency/Panic” button on the device 102j. A signal comprising data related to the last known position of the device 102j is then sent to the matching device 102i currently carried by the parent 128 at the home location. The route 138 between the home location and the park can thus be retraced using mapping software, such as Google Earth™, and displayed on the devices 102i, 102j so that the child 130 may find the way back home or be rescued at his or her current location. The antenna 122 provided at the home location illustratively allows for the locative information of the device 102j to be sent to a security service provider such as a 911 dispatcher in the case of an emergency.

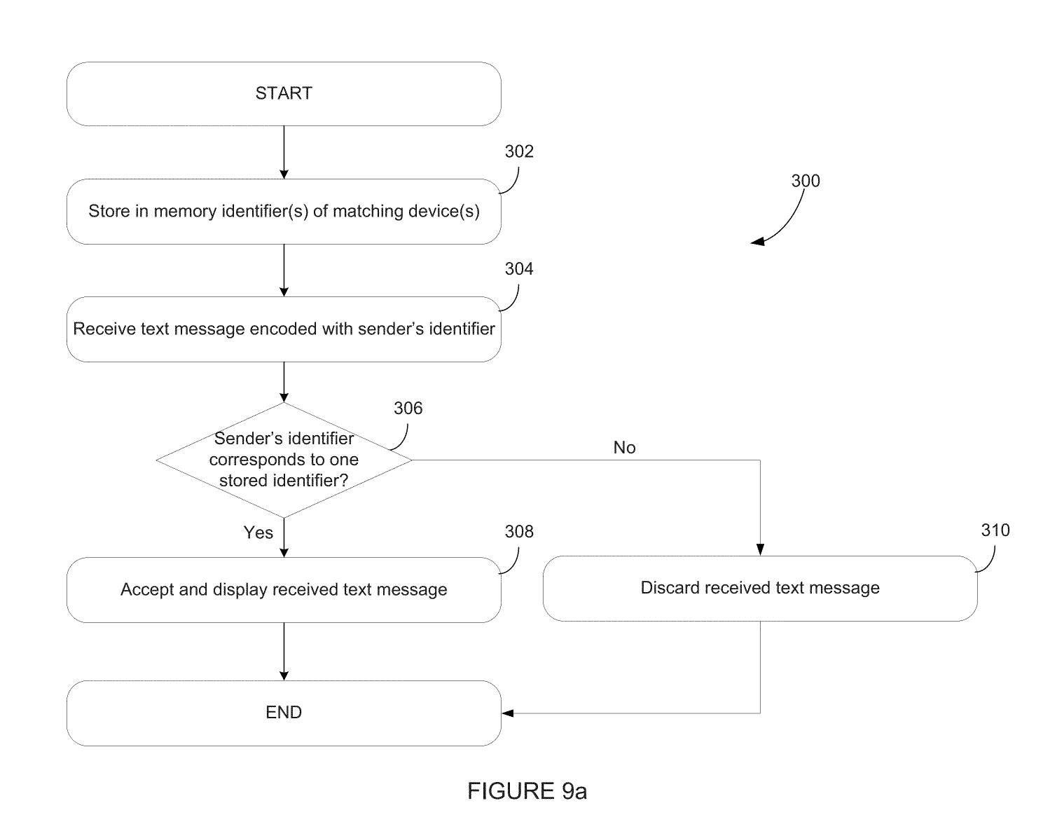

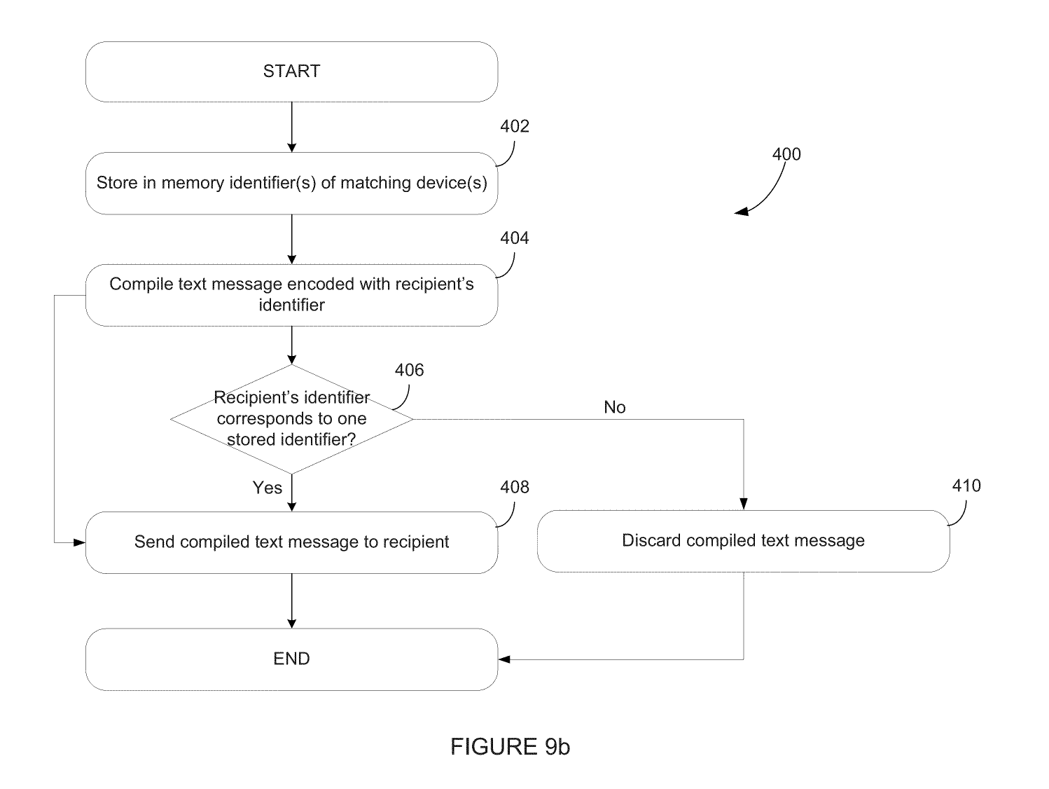

Referring to FIG. 9a, a method 300 for receiving a text message over short distances and low frequencies will now be described. The method 300 comprises storing at step 302 identifier(s) of matching device(s) in the memory of the receiving device. As discussed above, the identifier(s) illustratively correspond to previously identified IDs of devices matching the receiving device. The next step 304 may then be to receive a text message encoded with the sender's identifier. The method 300 may then flow to the step 306 of assessing whether the sender's identifier corresponds to one of the stored identifiers. In this manner, it becomes possible to identify whether the text message has been sent from a device entitled to communicate with the receiving device. If this is the case, the next step 308 may be to accept and display the received text message. Otherwise, the received text message may be discarded at step 310.

Referring to FIG. 9b, a method 400 for sending a text message over short distances and low frequencies will now be described. The method 400 comprises storing at step 402 identifier(s) of matching device(s) in the memory of the sending device. The next step 404 may then be to compile a text message encoded with the recipient's identifier. The method 400 may then flow to the step 406 of assessing whether the recipient's identifier corresponds to one of the stored identifiers. If this is the case, the next step 408 may be to send the compiled text message to the recipient. Otherwise, the compiled text message may be discarded at step 410. As discussed above, in some cases, each device may only be able to communicate with a single matching device and there will be no need for the user to specify a recipient. The compiled text message may then be sent directly to the recipient at step 408 without going through step 406. In other cases, the recipient may be selected from a list of previously identified devices presented to the user on their device. In this manner, the recipient is always a matching device and the method 400 need not check the recipient's authentication credentials at step 406. Instead, the method 400 may directly flow to the step 408 of sending the compiled message after the step 404 of compiling the text message.

While illustrated in the block diagrams as groups of discrete components communicating with each other via distinct data signal connections, it will be understood by those skilled in the art that the present embodiments are provided by a combination of hardware and software components, with some components being implemented by a given function or operation of a hardware or software system, and many of the data paths illustrated being implemented by data communication within a computer application or operating system. The structure illustrated is thus provided for efficiency of teaching the present embodiment.

It should be noted that the present invention can be carried out as a method, can be embodied in a system, a computer readable medium or an electrical or electro-magnetic signal. The embodiments of the invention described above are intended to be exemplary only. The scope of the invention is therefore intended to be limited solely by the scope of the appended claims.

1. A portable telecommunication apparatus for wirelessly sending and receiving text messages, the apparatus comprising:
a memory for storing at least one matching device identifier associated with the apparatus, the at least one matching device identifier corresponding to at least one matching device for which the apparatus is enabled to send and receive the text messages;
a transceiver for sending and receiving the text messages over a wireless personal area network, the received text messages each having encoded therewith a unique sender identifier corresponding to an originating device;
a processor for comparing the sender identifier from a received text message to the at least one matching device identifier and accepting the received text message when the sender identifier corresponds to the at least one matching device identifier; and
a display module for displaying the accepted text message.

2. The apparatus of claim 1, wherein the processor is for discarding the received text message when the sender identifier does not correspond to the at least one matching device identifier.

3. The apparatus of claim 1, wherein the memory has stored therein a single matching device identifier corresponding to a single matching device for which the apparatus is enabled to send and receive the text messages and further wherein the processor is for creating outgoing text messages each having encoded therewith a unique recipient identifier corresponding to the matching device and causing the transceiver to send the outgoing text messages to the matching device.

4. The apparatus of claim 1, wherein the processor is for creating an outgoing text message having encoded therewith a unique recipient identifier corresponding to a destination device, comparing the recipient identifier from the outgoing text message to the at least one matching device identifier, and causing the transceiver to send the outgoing text message to the destination device when the recipient identifier corresponds to the at least one matching device identifier.

5. The apparatus of claim 4, wherein the processor is for discarding the outgoing text message when the recipient identifier does not correspond to the at least one matching device identifier.

6. The apparatus of claim 1, wherein the transceiver is for sending and receiving the text messages over a short communication range within a geographical area.

7. The apparatus of claim 6, wherein the transceiver is for sending and receiving the text messages over at least several hundred meters.

8. The apparatus of claim 6, wherein the transceiver is for sending and receiving the text messages over ZigBee™ using at least one open-radio frequency.

9. The apparatus of claim 8, wherein the transceiver is for sending and receiving the text messages using a radio frequency of 2.4 GHz.

10. The apparatus of claim 6, wherein the transceiver is for sending and receiving the text messages over a mesh network comprising the apparatus and the at least one matching device.

11. The apparatus of claim 1, further comprising a localization unit adapted to record a location of the apparatus and to transmit the location to the at least one matching device.

12. A telecommunication system for wirelessly sending and receiving text messages within a geographical area, the system comprising:
a portable apparatus comprising
a memory for storing at least one matching device identifier associated with the apparatus, the at least one matching device identifier corresponding to at least one matching device for which the apparatus is enabled to send and receive the text messages,
a transceiver for sending and receiving the text messages over a wireless personal area network within a given communication range, the received text messages each having encoded therewith a unique sender identifier corresponding to an originating device,
a processor for comparing the sender identifier from a received text message to the at least one matching device identifier and accepting the received text message when the sender identifier corresponds to the at least one matching device identifier, and
a display module for displaying the accepted text message; and
a portable antenna provided within the geographical area for amplifying a signal sent by the transceiver, thereby increasing the communication range of the transceiver.

13. A computer-implemented method for wirelessly sending and receiving text messages, the method comprising executing on a processor program code for:
storing at least one matching device identifier associated with a portable telecommunication apparatus, the at least one matching device identifier corresponding to at least one matching device for which the apparatus is enabled to send and receive the text messages;
sending and receiving the text messages over a wireless personal area network, the received text messages each having encoded therewith a unique sender identifier corresponding to an originating device;
comparing the sender identifier from a received text message to the at least one matching device identifier and accepting the received text message when the sender identifier corresponds to the at least one matching device identifier; and
displaying the accepted text message.

14. The method of claim 13, wherein storing at least one matching device identifier comprises storing a single matching device identifier corresponding to a single matching device for which the apparatus is enabled to send and receive the text messages and further wherein the method further comprises creating outgoing text messages each having encoded therewith a unique recipient identifier corresponding to the matching device and sending the outgoing text messages to the matching device.

15. The method of claim 13, further comprising creating an outgoing text message having encoded therewith a unique recipient identifier corresponding to a destination device, comparing the recipient identifier from the outgoing text message to the at least one matching device identifier, and sending the outgoing text message to the destination device when the recipient identifier corresponds to the at least one matching device identifier.

16. The method of claim 15, further comprising discarding the outgoing text message when the recipient identifier does not correspond to the at least one matching device identifier.

17. The method of claim 13, further comprising discarding the received text message when the sender identifier does not correspond to the at least one matching device identifier.

18. The method of claim 13, further comprising recording a location of the apparatus and transmitting the location to the at least one matching device.

19. A computer readable medium having stored thereon program code executable by a processor for wirelessly communicating text messages, the program code executable for:
storing at least one matching device identifier associated with a portable telecommunication apparatus, the at least one matching device identifier corresponding to at least one matching device for which the apparatus is enabled to send and receive the text messages;
sending and receiving the text messages over a wireless personal area network, the received text messages each having encoded therewith a unique sender identifier corresponding to an originating device;
comparing the sender identifier from a received text message to the at least one matching device identifier and accepting the received text message when the sender identifier corresponds to the at least one matching device identifier; and
displaying the accepted text message.
